(19) United States
(12) Patent Application Publication
(10) Pub. No.: US 2025/0164423 A1
(43) Pub. Date: May 22, 2025

(54) DEEP LEARNING OF BISMUTH TELLURIDE CRYSTAL SIZE AND GRAIN BOUNDARIES FOR PREDICTIVE PERFORMANCE

(71) Applicant: ATS IP, LLC, Fort Collins, CO (US)

(72) Inventors: Jake Perez, Fort Collins, CO (US); Ion Basa, Fort Collins, CO (US); Ronald Petkie, Fort Collins, CO (US); Kelly Adams, Edmonton (CA)

(21) Appl. No.: 18/842,189

(22) PCT Filed: Mar. 13, 2023
(86) PCT No.: PCT/US2023/015128

§ 371 Date: Aug. 28, 2024

Related U.S. Application Data
(60) Provisional application No. 63/319,487, filed on Mar. 14, 2022.

(51) Int. Cl. G01N 23/2251; G06T 7/00; G06V 10/70

(52) U.S. Cl. CPC G01N 23/2251; G06T 7/0004; G06V 10/768; G06T 2207/10061; G06T 2207/20081; G06T 2207/30148

(57) ABSTRACT

Systems and methods herein provide for automated measurement and synthesis platforms coupled with AI and/or ML for the syntheses of new materials. One system includes a database comprising a plurality of training datasets. Each training dataset comprises a SEM image of a semiconductor wafer, an EDS/EDAX image of the wafer, an EBSD image of the wafer, and zT values of semiconductor components of the wafer. The system also includes a processor operable to implement a machine learning module that, when trained with the training datasets, is operable to process an input dataset of another semiconductor wafer through the machine learning module to predict zT values of semiconductor components of the other wafer. The input dataset of the other wafer comprises an SEM image of the other wafer, an EDS/EDAX of the other wafer, and an electron backscatter diffraction (EBSD) of the other wafer.

### CROSS REFERENCE TO RELATED APPLICATIONS

This patent application claims priority to, and thus the benefit of an earlier filing date from, U.S. Provisional Patent Application No. 63/319,487 (filed Mar. 14, 2022), the contents of which are hereby incorporated by reference.

### BACKGROUND

Bismuth telluride is a semiconductor material used in the construction of thermoelectric generators (TEGs). But bulk bismuth telluride synthesis is sensitive to the creation of grain boundaries of semiconductor components during sintering. For example, during the sintering process, excess material, dopants, and contaminants can accumulate at grain boundaries of semiconductor modules on a semiconductor wafer. The sintering process can also affect the size and structure of material grains and crystals. Controlling these grain boundaries, grains, and crystals are important for developing high performance thermoelectric material. Excess materials, also known as precipitates, at the grain boundaries can impede electron and phonon flow through the material, which can decrease electrical conductivity of the semiconductor modules. Decreasing electrical conductivity through grain boundaries degrades device performance. Contrastingly, impeding phonon flow decreases thermal conductivity, which can increase device performance. So, it remains a difficult balance between electrical conductivity and phonon flow.

The Office of Basic Energy Sciences (BES) roundtable is exploring the production and management of large amounts of scientific data to automate data collection processes of scanning electron microscopes (SEM), energy-dispersive spectroscopy (EDS/EDAX), and electron backscatter diffraction (EBSD) for use in determining crystal size and grain boundaries within crystalline semiconductor materials. The BES has initiated broad areas of research including automating facility control, enabling higher reliability, reaching physics-limited capabilities, and automating experimental processes.

SEMs provide an integral understanding of material synthesis by revealing grain boundaries and crystal sizes within physical materials. Analysis of grain boundaries and crystal sizes provide valuable insight into the quality and performance of materials. For example, grain boundaries and crystals can be visualized with an SEM on a plane of the sample material, such as bismuth telluride. However, identifying grain boundaries and their precipitates requires significant time due to manual research.

### SUMMARY

Systems and methods herein provide for automated measurement and synthesis platforms coupled with artificial intelligence (AI) and/or machine learning (ML) algorithms, which can lead to scientific discoveries and lead to the syntheses of new materials. These systems and methods also free research experts from the data collection process to give them time to focus on understanding higher level problems and emerging trends from the data collected.

In one embodiment, a system includes a database comprising a plurality of training datasets. Each training dataset comprises a scanning electron microscope (SEM) image of a semiconductor wafer (e.g., a bismuth tellurium wafer) an energy-dispersive spectroscopy (EDS/EDAX) image of the wafer, an electron backscatter diffraction (EBSD) image of the wafer, and zT values of semiconductor components of the wafer. The system also includes a processor operable to implement a machine learning module that, when trained with the training datasets, is operable to process an input dataset of another semiconductor wafer (e.g., another bismuth tellurium wafer) through the machine learning module to predict zT values of semiconductor components of the other wafer. The input dataset of the other wafer comprises an SEM image of the other semiconductor wafer, an EDS/EDAX image of the other wafer, and an EBSD image of the other wafer.

In some embodiments, the machine learning module may be used to identify grain boundaries of the other wafer, identify precipitates at the grain boundaries of the other wafer, and/or identify crystalline properties of the other wafer. The machine learning module may be implemented in a variety of ways as a matter of design choice, including using one or more of a supervised learning algorithm, a semi-supervised learning algorithm, an unsupervised learning algorithm, a regression analysis algorithm, a reinforcement learning algorithm, a self-learning algorithm, a feature learning algorithm, a sparse dictionary learning algorithm, an anomaly detection algorithm, a generative adversarial network, a convolutional neural network, a transfer learning algorithm, and an association rules algorithm.

The various embodiments disclosed herein may be implemented in a variety of ways as a matter of design choice. For example, some embodiments herein are implemented in hardware whereas other embodiments may include processes that are operable to implement and/or operate the hardware. Other exemplary embodiments, including software and firmware, are described below.

### BRIEF DESCRIPTION OF THE FIGURES

Some embodiments of the present invention are now described, by way of example only, and with reference to the accompanying drawings. The same reference number represents the same element or the same type of element on all drawings.

FIG. 1 is a block diagram of an exemplary a system for machine learning zT values of a semiconductor wafer.

FIG. 2 is a flowchart of an exemplary process of the system of FIG. 1.

FIG. 3 is a block diagram of another exemplary a system for machine learning zT values of a semiconductor wafer.

FIG. 4 is a photograph of an SEM image of an exemplary semiconductor wafer.

FIG. 5 is an EDS/EDAX image showing bismuth deposits on the semiconductor wafer of FIG. 4.

FIG. 6 is an EDS/EDAX image showing tellurium deposits on the semiconductor wafer of FIG. 4.

FIG. 7 is an EDS/EDAX image showing selenium deposits on the semiconductor wafer of FIG. 4.

FIG. 8 is an overlay image of FIGS. 5-7 on the image of FIG. 4 illustrating the bismuth, tellurium, and selenium deposits on the semiconductor wafer.

FIG. 9 is a graph illustrating the bismuth, tellurium, and selenium deposits on the semiconductor wafer.

FIG. 10 is a block diagram of an exemplary computing system in which a computer readable medium provides instructions for performing methods herein.

### DETAILED DESCRIPTION OF THE FIGURES

The figures and the following description illustrate specific exemplary embodiments. It will thus be appreciated that those skilled in the art will be able to devise various arrangements that, although not explicitly described or shown herein, embody certain principles and are included within the scope of the embodiments. Furthermore, any examples described herein are intended to aid in understanding the embodiments and are to be construed as being without limitation to such specifically recited examples and conditions. As a result, the embodiments are not limited to any of the examples described below.

SEMs can be used to determine average grain sizes and overall boundary lengths in the analysis of a thermoelectric material, such as bismuth telluride, to determine more information about grain boundaries and precipitates. By coupling SEM images with EDS/EDAX and/or EBSD imagery, the embodiments herein can be used to quantitatively measure the composition of excess materials accumulated at the grain boundaries. These grain boundaries, precipitates, and grain sizes have a material correlation to zT, which is useful in understanding the thermoelectric quality of semiconductor material.

¿T is a dimensionless figure of merit used in thermoelectric research to describe the efficiency of a thermoelectric material, zT is defined as zT=S\hat{ }2*σ*T/κ, where S is the Seebeck coefficient, σ is the electrical conductivity, κ is the thermal conductivity, and T is the absolute temperature. A higher zT value indicates a more efficient thermoelectric material, meaning that it can convert a larger amount of heat into electricity. Typically, a material with a zT value above 1 is considered to be a good thermoelectric material, while a zT value of 2 or higher is considered to be excellent. The embodiments herein have been used to obtain zT values as high as 2.6.

The Seebeck coefficient (a.k.a., the thermoelectric power or thermopower) is a material property that describes the magnitude of the electric potential difference that is generated across a temperature gradient in a material. When two dissimilar materials are joined together at two different temperatures, an electric potential difference is generated between them, which is proportional to the temperature difference. The Seebeck coefficient is defined as the ratio of the electric potential difference to the temperature difference between the two materials, expressed in units of microvolts per Kelvin (μV/K). The Seebeck coefficient depends on the properties of the material, such as its electronic structure, crystal structure, and carrier concentration. The Seebeck coefficient is an important parameter for the design and optimization of thermoelectric materials, which can be used to convert waste heat from power plants and other industrial processes into electricity, and/or can be used in cooling applications.

By coupling SEM imagery with EDS/EDAX and/or EBSD imagery, the crystallographic orientation and chemical composition of each grain and principates can be determined. This data can be mapped into appropriate spaces, such as Rodrigues-Frank orientation space for analysis (e.g., in the homochoric domain), which can be statistically analyzed by convolution space algorithms to illuminate the micro-texture preferences as a function of the data. The meso-texture, which is the statistical relationship of grain boundary misorientation, can also be determined computationally and mapped into the appropriate misorientation space with respect to the Rodrigues-Frank space related to its crystal structure. Meso-texture is important in understanding the nature of charge carrier transport, and thus, the nature of zT. It is well-known that charge carrier transport is determined by grain boundary misorientation rather than grain orientation, as seen in solar cell technology.

The embodiments herein use AI and/or ML to import large image datasets obtained via SEM, EDAX, and/or EBSD and employ algorithms to determine the grain size, grain material, grain boundary distribution, percent precipitate at the grain boundaries, precipitate material, average grain boundary length, grain orientation, grain size distribution, and the like. Multiple initiatives are used to accomplish this, including: a method to automate SEM-EDAX image collection; an image processor that stiches multiple SEM images into a canvas; an AI/ML algorithm to analyze canvases from compiled SEM imagery; training datasets that are used to train the AI/ML algorithm. Artificial neural networks and/ML can also be used to read and analyze crystal structure and automate time consuming manual tasks.

In this regard, thermoelectric sample wafers having a variety of zT values are manufactured. Then, using automation of SEM-EDAX-EBSD image collection, images will be taken of the various manufactured wafers. These same wafers will have extensive performance characterizations to understand electrical conductivity, thermal conductivity, and Seebeck voltage. Once these are complete, the SEM-EDAX-EBSD images and associated performance data are used as the training datasets.

An image processor may be used to stitch multiple SEM-EDAX-EBSD images into a canvas. Then, an AI/ML algorithm analyzes the canvas images and their datasets. Types of artificial neural networks (ANN) that may be used for this purpose include convolutional neural networks (CNNs) and reservoir computing. CNNs are often used for image processing due to their ability to break down the image and information over many kernels. Reservoir computing offers a differing approach where interior layers are randomly connected and trained, allowing the training set to only modify the input and output layer. A training dataset with information, performance data, images, and/or grain boundary information is used to train the ANN and increase its accuracy. Then, this information is combined to link SEM photos to predictive performance. In some embodiments, a machine learning algorithm processes a compilation of SEM readings and uses image recognition to identify grain boundaries and their precipitates within thermoelectric material.

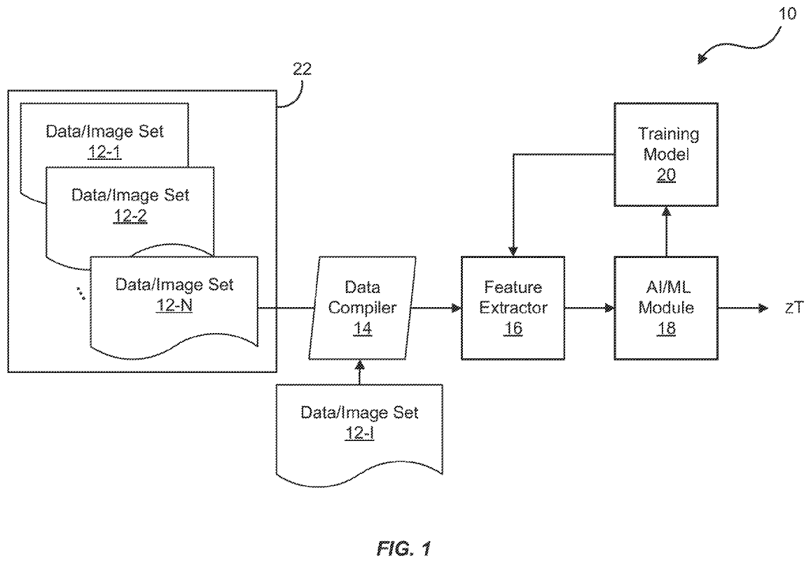

FIG. 1 is a block diagram of an exemplary system 10 for machine learning zT values of a semiconductor wafer. In this embodiment, the system 10 includes a data compiler 14, a feature extractor 16, an AI/ML module 18, and a training model 20. The data compiler 14 is operable to receive a plurality of data/image sets 12-1-12-N from a database 22 (where the reference number “N” indicates an integer greater than “1” and not necessarily equal to any other “N” reference designated herein). Each of the data/image sets 12 may include SEM imagery of a semiconductor wafer (e.g., a bismuth tellurium wafer), EDAX imagery of the wafer, EBSD imagery of the wafer, zT values of semiconductor components of the wafer, and other data associated with the wafer. Generally, the imagery is on a microscopic level. And, as such, the imagery includes multiple images (e.g., thousands) obtained at various locations on the wafer. These images may be stitched together to provide an overall image of the wafer.

The data compiler 14 arranges the data and imagery of the data/image sets 12 such that features of a semiconductor wafer (e.g., grain boundaries, precipitates, grain sizes, etc.) can be extracted from its associated data/image set 12 by a feature extractor 16. The features of each of the wafers are then used to train the AI/ML module 18 to build a training model 20. The training model 20 may then be fed back to the feature extractor 16 such that, when an input data/image set 12-I of another semiconductor wafer is input to the system 10 for analysis, the training model 20 and the input data/image set 12-I can be fed into the machine learning module 18 to determine the zT values of the semiconductor components of the other semiconductor wafer.

In this regard, the data compiler 14 arranges the data and imagery of the data image set 12-I in a manner consistent with the data/image sets 12 used to train the machine learning module 18. The feature extractor 16 may then extract the features of the other semiconductor wafer for an artificial intelligence/machine learned comparison to the other data/image sets 12 such that the zT values of the semiconductor components of the input data/image set 12-I pertaining to the other semiconductor wafer can be obtained (i.e., without time-consuming manual research).

Based on the foregoing, the data compiler 14 is any system, device, software, or combination thereof operable to process data/image sets 12 of semiconductor wafers for use in training and AI/ML module 18. The feature extractor 16 is any system, device, software, or combination thereof operable to extract features of the semiconductor wafer from the processed data and imagery produced by the data compiler 14. The AI/ML module 18 is any system, device, software, or combination thereof operable to learn the extracted features of the semiconductor wafer from the feature extractor 16 so as to generate a training model 20, which may then be used to learn the features of another semiconductor wafer (e.g., grain boundaries, precipitates, grain sizes, etc.) such that identified features in the other semiconductor wafer can be predicted. The data compiler 14, the feature extractor 16, and/or the AI/ML module 18 may be implemented by one or more computer processors. Examples of such computer processors include specialized graphics cards capable of parallel computing, devices that are useful in artificial intelligence and machine learning.

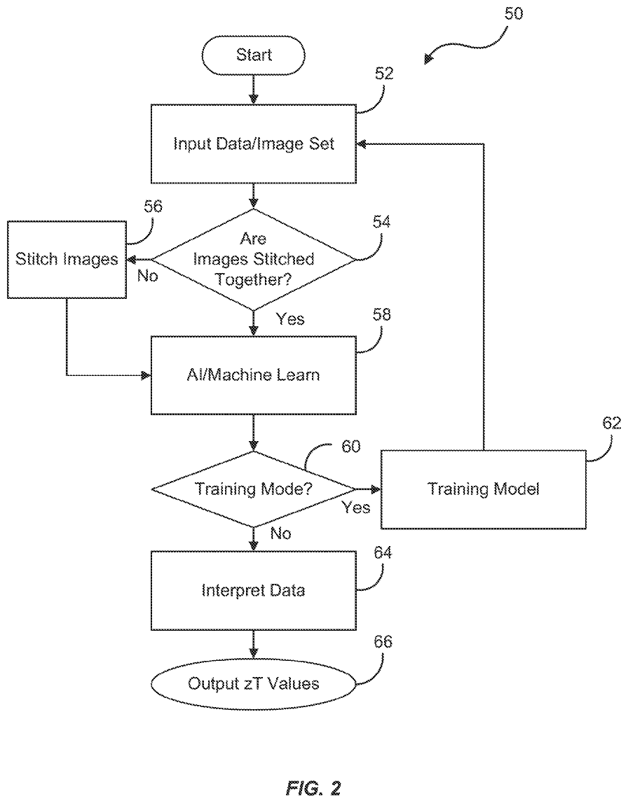

FIG. 2 is a flowchart of an exemplary process 50 of the system 10 of FIG. 1. In this embodiment, the process 50 initiates by inputting a data/image set 12 into the system 10, in the process element 52. The process 50 then determines whether the images of the input data/image set 12 are stitched together, in the process element 54. If not, the data compiler 14 may stitch the images of the associated semiconductor wafer so as to provide a canvas of imagery of the semiconductor wafer, in the process element 56. The feature extractor 16 and the AI/ML module 18 may then machine learn the features of the semiconductor wafer associated with the data/image set 12, in the process element 58. If, however, the images are stitched together in the process element 54, then the feature extractor and the AI/ML module 18 will automatically learn the features of the associated semiconductor wafer, in the process element 58.

Once the features are learned by the AI/ML module 18, the system 10 will determine whether the system 10 is in a training mode, in the process element 60. If so, the system 10 adds the learned data/image set 12 to the training model 20, in the process element 62, and the system returns to the process element 52 to learn the next data/image set 12. Once the training model 20 has been built using the desired number of data/image sets 12, the feature extractor 16 and the AI/ML module 18 are ready to learn the features of an input data/image set 12-I.

In this regard, the input data/image set 12-I is input to the data compiler 14 to obtain all of the data and imagery pertaining to a new semiconductor wafer, in the process element 52. Again, the data compiler 14 determines whether the images associated with the new semiconductor wafer are stitched together (i.e., the process elements 54 and 56). From there, the feature extractor 16 in the AI/ML module 18 will attempt to learn the features of the new semiconductor wafer using the built training model 20 from the process element 62. As such, the system 10 will determine that the system 10 is no longer in a training mode, in the process element 60, and the AI/ML module 18 will interpret the data, in the process element 64, to determine the zT values of the semiconductor components of the newly input semiconductor wafer. The system will then output the zT values, in the process element 66, such that the individual semiconductor components of the semiconductor wafer can be evaluated for use in a thermoelectric device (e.g., a thermoelectric generator).

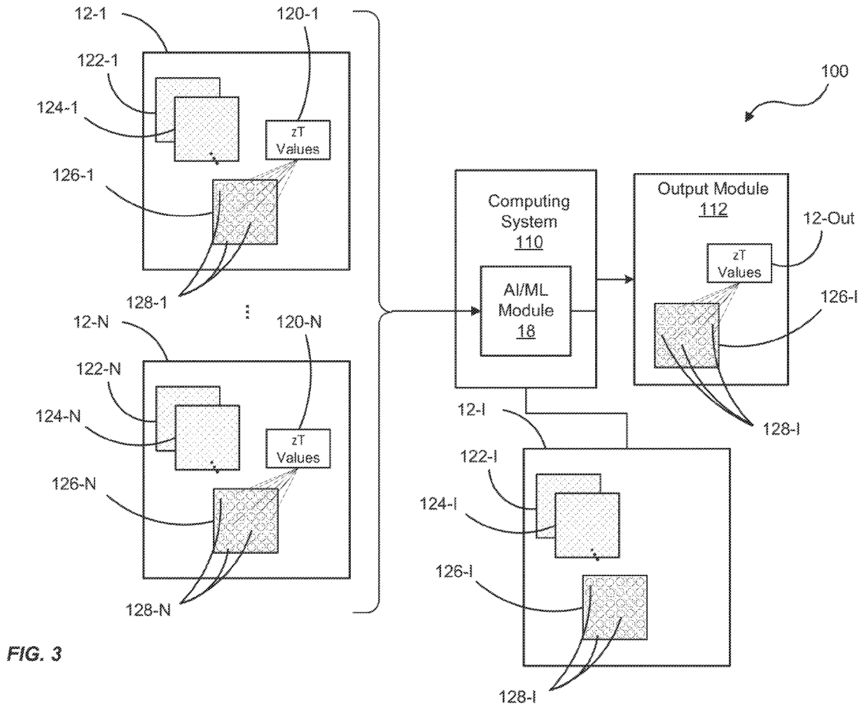

FIG. 3 is a block diagram of another exemplary a system 100 for machine learning ¿T values of a semiconductor wafer. In this embodiment, the system 100 is operable to process a plurality of data/image sets 12-1-12-N to train the AI/ML module 18. The AI/ML module 18 is implemented in a computing system 110 (e.g., using parallel processing graphics cards, computer processors, computer memory, etc.) each of the data/image sets 12 includes at least one SEM image 126-1 that is been stitched together to provide a canvas SEM imagery of a semiconductor wafer (e.g., a bismuth telluride semiconductor wafer used for forming thermoelectric devices, such as thermoelectric generators).

Each of the data/image sets 12 may also include one or more images of its respective semiconductor wafer including, for example, an EDS/EDAX image 122 and/or an EBSD image 124. The images 122 and 124 may be overlaid on the SEM image 126 to illustrate the various features of the semiconductor wafer (e.g., grain boundaries, precipitates, grain sizes, etc.), which are used to train the AI/MI module 18. The data/image sets 12 also include ZT values 120 for the semiconductor components 128 of the semiconductor wafer.

Once the AI/ML module 18 has been trained, the computing system 110 may input a data/image set 12-I of another semiconductor wafer to the AI/ML module 18 for feature extraction and zT prediction of the semiconductor components 128-I of the other semiconductor wafer. Once the features of the other semiconductor wafer and the zT values of the other semiconductor wafer have been learned by the AI/ML module 18, the output module 112 may output the SEM image 126-I with the zT values 120-Out of the semiconductor components 128-I such that the semiconductor components 128-I can be evaluated for their use in thermoelectric devices.

The AI/ML module 18 may be implemented in a variety ways as a matter of design choice. For example, the AI/ML module 18 may employ one or more of a supervised learning algorithm, a semi-supervised learning algorithm, an unsupervised learning algorithm, a regression analysis algorithm, a reinforcement learning algorithm, a self-learning algorithm, a feature learning algorithm, a sparse dictionary learning algorithm, an anomaly detection algorithm, a generative adversarial network, a convolutional neural network, a transfer learning algorithm, an association rules algorithm, or the like. Accordingly, the systems 10 and 100 are not intended to be limited to any particular semiconductor wafer feature learning algorithm. Additionally, while the terms AI and ML may represent different ways of approaching computationally learned aspects of semiconductor wafers, the two terms may be represented and claimed herein collectively as ML, or machine learning.

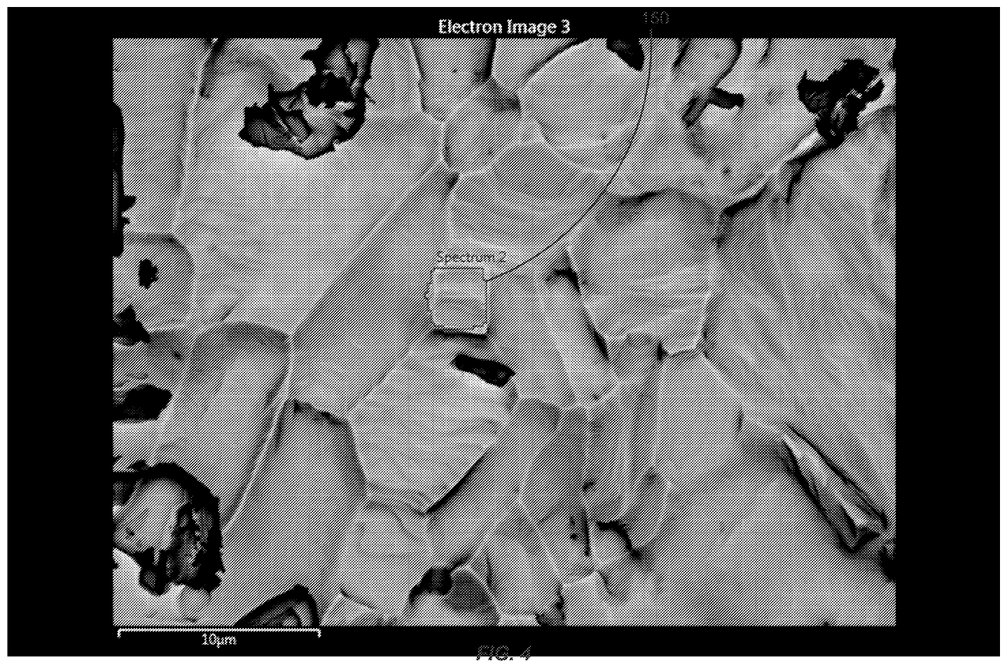

FIG. 4 is a photograph of an SEM image of an exemplary semiconductor wafer. The image shows a surface image of a bismuth telluride crystalline material semiconductor wafer without any EDS or EDAX composite overlay. This image may be used to identify the grain boundaries of each crystal formation in the semiconductor wafer, such as those of the semiconductor component 150 on the semiconductor wafer. Due to the collimator of the SEM, multiple images are taken in sequence to cover the entire area of the wafer. These images may then be stitched together to create a larger image of the wafer at the same magnification level on the SEM. This is generally a non-destructive way to look at the surface of the semiconductor wafer. Alternatively, once the semiconductor wafer has been diced into pellets, the same stitching can be performed on the sides of the pellets (e.g., Z-axis) to reveal the internal crystal structures.

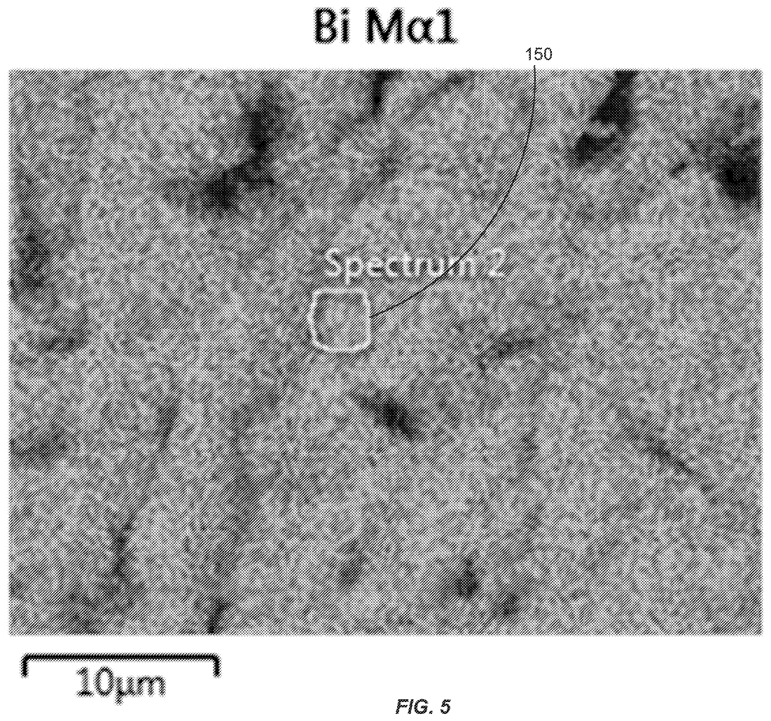

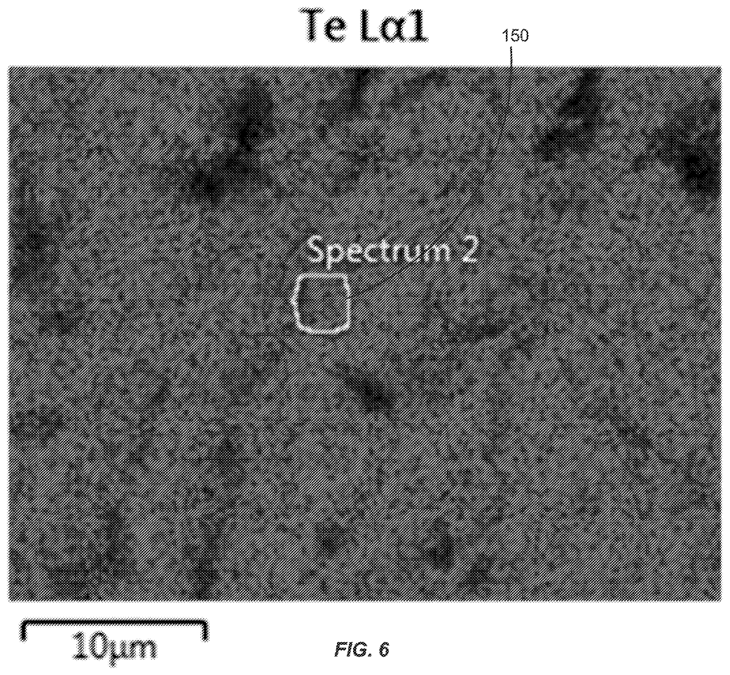

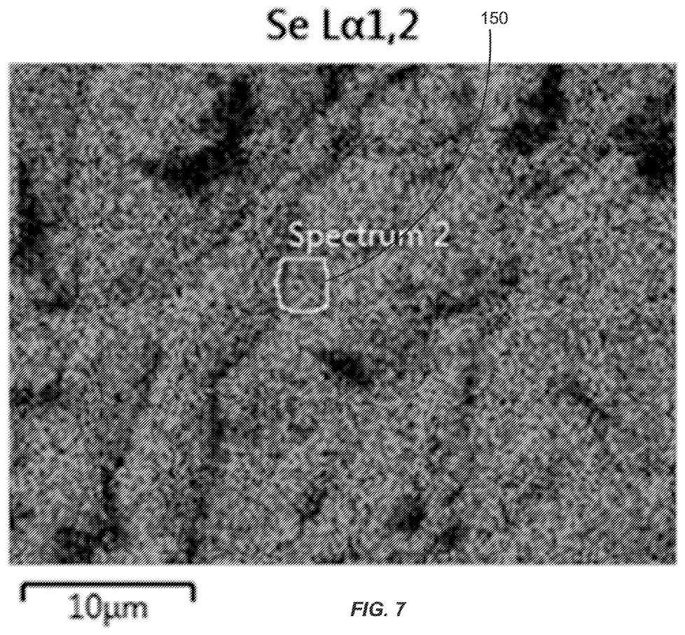

FIG. 5 is an EDS/EDAX image showing bismuth deposits on the semiconductor wafer of FIG. 4. FIG. 6 is an EDS/EDAX image showing tellurium deposits on the semiconductor wafer of FIG. 4. FIG. 7 is an EDS/EDAX image showing selenium deposits on the semiconductor wafer of FIG. 4.

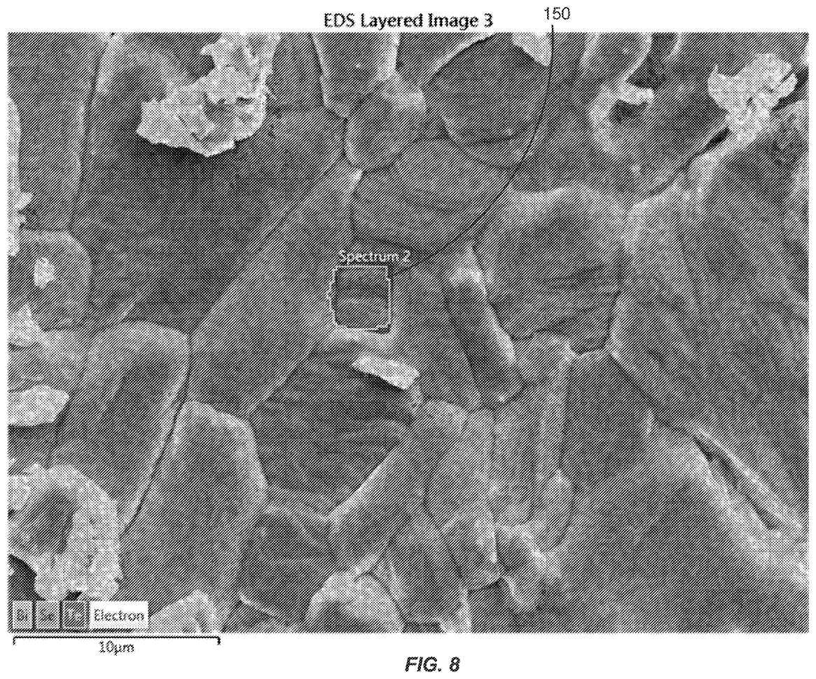

FIG. 8 is an overlay image of FIGS. 5-7 on the image of FIG. 4 illustrating the bismuth, tellurium, and selenium deposits on the semiconductor wafer. In this embodiment, EDS/EDAX imagery is overlaid on the SEM image of FIG. 4 to illustrate the primary materials in the semiconductor wafer (i.e., bismuth, tellurium, selenium, etc.) in an n-type semiconductor material used for thermoelectric devices, as illustrated in FIG. 8. The composite image and its three main elements, each being represented by their associated color (see e.g., the legend in the bottom left), in the semiconductor wafer, was generated using EDS. Generally, a scientist would interpret this composite image to determine the various features of the semiconductor wafer (e.g., grain boundaries, precipitates, grain sizes, zT values, etc.), such as those of the semiconductor component 150 of the wafer. However, this process is prone to human error and/or human biases.

As can be seen in this composite image, there is a relative density of the three main materials-bismuth, tellurium, and selenium. Areas of concern are visible as “hot spots” in the wafer where excess materials can form during semiconductor wafer manufacturing. These hot spots are essentially defects which can form from process conditions during manufacturing, including temperature of a sintering profile, pressure on the semiconductor wafer during the sintering profile, elemental composition, and uneven mixing of materials prior to manufacturing. These defects are known to occur and can be generated purposefully if desired (e.g., for testing) but are generally undesired for product use.

The density population of each element can be generated from the composite image of FIG. 8. FIGS. 5-7 are essentially point clouds of the discrete elements (i.e., bismuth in FIG. 5, tellurium in FIG. 6, and selenium in FIG. 7). The goal in manufacturing semiconductor wafers is to have an even population density distribution relative to the desired formulation with minimal to no aggregation at grain boundaries on the semiconductor wafer. The systems 10 and 100 may be operable to learn these features so as to determine the zT values of the semiconductor components of the semiconductor wafer for evaluation of their use in thermoelectric devices.

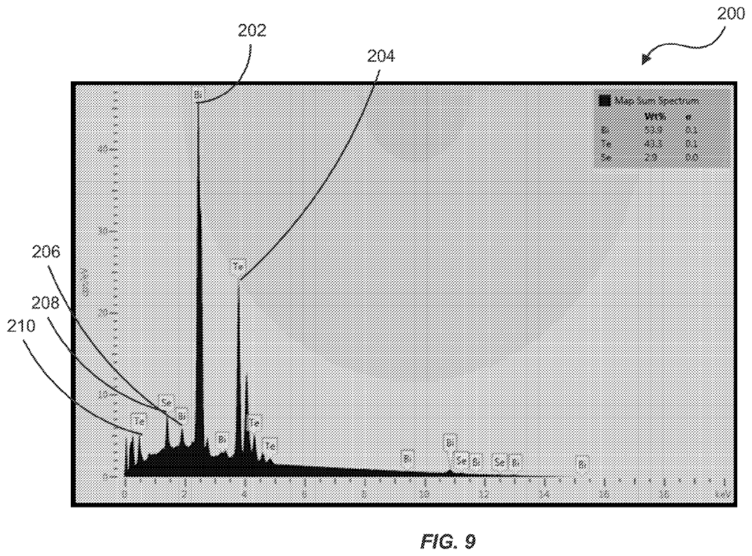

When combined with the EDS/EDAX imagery of FIGS. 5-7, material peaks of the various materials in the semiconductor wafer can be determined in the SEM image of FIG. 4 by counting the numbers of electrons at each energy level, which corresponds to the elements. This spectrum map is illustrated in FIG. 9. For example, FIG. 9 is a graph illustrating the bismuth, tellurium, and selenium deposits on a semiconductor wafer. Here, the y-axis is measured in the “counts per second per electron volt.” The x-axis is measured in kilo-electron volts. The peaks 202-210 on the distribution in the graph reflect a fingerprint of each material. This fingerprint may be used as one of the features of each data/image set 12 input to the AI/ML module 18 (i.e., for training the AI/ML module 18 and/or analyzing a subsequent semiconductor wafer).

In summary, zT is a composite of thermal conductivity, electrical conductivity, and the Seebeck coefficient. For a high zT, a low thermal conductivity is desired, while high electrical conductivity and high Seebeck coefficient are desired. The inputs to the AI/ML module 18 may be able to discern these base components and determine a zT after training. The SEM and chemical composition (i.e., EDAX imagery) may be used to discern the presence and locations of grain boundaries, their size, how prevalent they are, and what chemicals they consist of. The AI/ML module 18 may then determine the thermal and electrical conductivity of a subsequent semiconductor wafer under analysis. The AI/ML module 18 may also determine the Seebeck effect from the bulk analysis chemical composition. Other measurements, such as Hall effect, may be used as a tool to reveal insights into the Seebeck coefficient and the electrical conductivity. These cumulative inputs may be used for high fidelity material science data that trains the AI ML module 18 to determine the zT of a subsequent semiconductor wafer after training.

While the embodiments herein may be particularly useful with materials such as bismuth tellurium, the embodiments may also be particularly useful in other multi-crystalline thermoelectric materials. Some examples of such materials include the following along with their estimated temperature ranges.

| | Temperature Range | | | | | | | | | |
|---|---|---|---|---|---|---|---|---|---|---|
| | 100 C. | 200 C. | 300 C. | 400 C. | 500 C. | 600 C. | 700 C. | 800 C. | 900 C. | 1000 C. |
| Material | GeTe | BiTe | Skutte- | PbTe | PbTe | (Sr,BaYb)yCo₄ | SnSe | SnSe | SiGe | SiGe |
| | | | rudite | | | | | | | |
| Material | | MgAgSb | | Te | TeAgGeSb | | | Cu₂Se | | |
| Material | | | | Mg_{3.2}Sb_{1.5}Bi_{0.49}Te_{0.01} | Mg_{3.2}Sb_{1.5}Bi_{0.49}Te_{0.01} | | | | | |
| Material | | | | | LAST | | | | | |
| Material | | | | | AgPbmSbTem₁₂ | | | | | |
| Material | | | | | Ba_{0.3}In_{0.3}Co₄Sb₁₂ | | | | | |

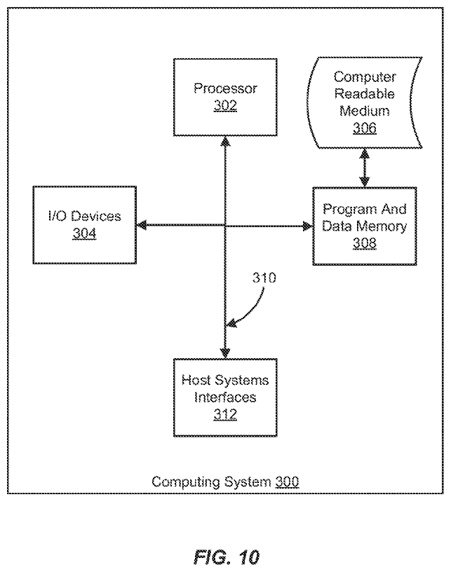

Any of the above embodiments herein may be rearranged and/or combined with other embodiments. Accordingly, the concepts herein are not to be limited to any particular embodiment disclosed herein. Additionally, the embodiments can take the form of entirely hardware or comprising both hardware and software elements. Portions of the embodiments may be implemented in software, which includes but is not limited to firmware, resident software, microcode, etc. FIG. 10 illustrates a computing system 300 in which a computer readable medium 306 may provide instructions for performing any of the methods disclosed herein.

Furthermore, the embodiments can take the form of a computer program product accessible from the computer readable medium 306 providing program code for use by or in connection with a computer or any instruction execution system. For the purposes of this description, the computer readable medium 306 can be any apparatus that can tangibly store the program for use by or in connection with the instruction execution system, apparatus, or device, including the computer system 300.

The medium 306 can be any tangible electronic, magnetic, optical, electromagnetic, infrared, or semiconductor system (or apparatus or device). Examples of a computer readable medium 306 include a semiconductor or solid state memory, magnetic tape, a removable computer diskette, a random access memory (RAM), NAND flash memory, a read-only memory (ROM), a rigid magnetic disk and an optical disk. Some examples of optical disks include compact disk-read only memory (CD-ROM), compact disk-read/write (CD-R/W) and digital versatile disc (DVD).

The computing system 300, suitable for storing and/or executing program code, can include one or more processors 302 coupled directly or indirectly to memory 308 through a system bus 310. The memory 308 can include local memory employed during actual execution of the program code, bulk storage, and cache memories which provide temporary storage of at least some program code in order to reduce the number of times code is retrieved from bulk storage during execution. Input/output or I/O devices 304 (including but not limited to keyboards, displays, pointing devices, etc.) can be coupled to the system either directly or through intervening I/O controllers. Network adapters may also be coupled to the system to enable the computing system 300 to become coupled to other data processing systems, such as through host systems interfaces 312, or remote printers or storage devices through intervening private or public networks. Modems, cable modem and Ethernet cards are just a few of the currently available types of network adapters.

1. A system, comprising:
a database comprising a plurality of training datasets, each training dataset comprising a scanning electron microscope (SEM) image of a semiconductor wafer, an energy-dispersive spectroscopy (EDS/EDAX) image of the wafer, an electron backscatter diffraction (EBSD) image of the wafer, and zT values of semiconductor components of the wafer; and
a processor operable to implement a machine learning module that, when trained with the training datasets, is operable to process an input dataset of another semiconductor wafer through the machine learning module to predict zT values of semiconductor components of the other wafer, the input dataset of the other wafer comprising an SEM image of the other wafer, an EDS/EDAX image of the other wafer, and an EBSD image of the other wafer.

2. The system of claim 1, wherein:
the machine learning module is operable to identify grain boundaries of the other wafer.

3. The system of claim 2, wherein:
the machine learning module is operable to identify precipitates at the grain boundaries of the other wafer.

4. The system of claim 1, wherein:
the machine learning module is operable to identify crystalline properties of the other wafer.

5. The system of claim 1, wherein:
the machine learning module comprises at least one of a supervised learning algorithm, a semi-supervised learning algorithm, an unsupervised learning algorithm, a regression analysis algorithm, a reinforcement learning algorithm, a self-learning algorithm, a feature learning algorithm, a sparse dictionary learning algorithm, an anomaly detection algorithm, a generative adversarial network, a convolutional neural network, a transfer learning algorithm, or an association rules algorithm.

6. The system of claim 1, wherein:
the semiconductor wafer is configured from bismuth tellurium.

7. A computer implemented method, comprising:
training a machine learning module with a plurality of training datasets, each training dataset comprising a scanning electron microscope (SEM) image of a semiconductor wafer, an energy-dispersive spectroscopy (EDS/EDAX) image of the wafer, an electron backscatter diffraction (EBSD) image of the wafer, and zT values of semiconductor components of the wafer; and
processing an input dataset of another semiconductor wafer through the machine learning module, the input dataset of the other wafer comprising an SEM image of the other semiconductor wafer, an EDS/EDAX image of the other wafer, and an EBSD image of the other wafer; and
predicting zT values of semiconductor components of the other wafer based on the processing of the input dataset of the other wafer through the machine learning module.

8. The method of claim 7, further comprising, via the machine learning module:
identifying grain boundaries of the other wafer.

9. The method of claim 8, further comprising, via the machine learning module:
identifying precipitates at the grain boundaries of the other wafer.

10. The method of claim 7, further comprising, via the machine learning module:
identifying crystalline properties of the other wafer.

11. The method of claim 7, wherein:
the machine learning module comprises at least one of a supervised learning algorithm, a semi-supervised learning algorithm, an unsupervised learning algorithm, a regression analysis algorithm, a reinforcement learning algorithm, a self-learning algorithm, a feature learning algorithm, a sparse dictionary learning algorithm, an anomaly detection algorithm, a generative adversarial network, a convolutional neural network, a transfer learning algorithm, or an association rules algorithm.

12. The method of claim 7, wherein:
the semiconductor wafer is configured from bismuth tellurium.

13. A non-transitory computer readable medium comprising instructions that, when executed by a processor, direct the processor to:
train a machine learning module with a plurality of training datasets, each training dataset comprising a scanning electron microscope (SEM) image of a semiconductor wafer, an energy-dispersive spectroscopy (EDS/EDAX) image of the wafer, an electron backscatter diffraction (EBSD) image of the wafer, and zT values of semiconductor components of the wafer; and
process an input dataset of another semiconductor wafer through the machine learning module, the input dataset of the other wafer comprising an SEM image of the other semiconductor wafer, an EDS/EDAX image of the other wafer, and an EBSD image of the other wafer; and
predict zT values of semiconductor components of the other wafer based on the processing of the input dataset of the other wafer through the machine learning module.

14. The computer readable medium of claim 13, further comprising instructions that direct the processor, via the machine learning module, to:
identifying grain boundaries of the other wafer.

15. The computer readable medium of claim 14, further comprising instructions that direct the processor, via the machine learning module, to:
identifying precipitates at the grain boundaries of the other wafer.

16. The computer readable medium of claim 13, further comprising instructions that direct the processor, via the machine learning module, to:
identifying crystalline properties of the other wafer.

17. The computer readable medium of claim 13, wherein:
the machine learning module comprises at least one of a supervised learning algorithm, a semi-supervised learning algorithm, an unsupervised learning algorithm, a regression analysis algorithm, a reinforcement learning algorithm, a self-learning algorithm, a feature learning algorithm, a sparse dictionary learning algorithm, an anomaly detection algorithm, a generative adversarial network, a convolutional neural network, a transfer learning algorithm, or an association rules algorithm.

18. The computer readable medium of claim 13, wherein:
the semiconductor wafer is configured from bismuth tellurium.
